(19) United States
(12) Patent Application Publication
(10) Pub. No.: US 2024/0087787 A1
(43) Pub. Date: Mar. 14, 2024

(54) COIL COMPONENT

(71) Applicant: TDK Corporation, Tokyo (JP)

(72) Inventors: Yuki HASHIMOTO, Tokyo (JP); Toshiyuki ABE, Tokyo (JP); Takeshi OKUMURA, Tokyo (JP); Tomonaga NISHIKAWA, Tokyo (JP); Naoaki FUJII, Tokyo (JP); Kazuhiro YOSHIKAWA, Tokyo (JP)

(21) Appl. No.: 18/463,649

(22) Filed: Sep. 8, 2023

(30) Foreign Application Priority Data
Sep. 12, 2022 (JP) 2022-144774

(51) Int. Cl. H01F 17/00; H01F 17/04; H01F 27/02

(52) U.S. Cl. CPC H01F 17/0013; H01F 17/04; H01F 27/022; H01F 27/292

(57) ABSTRACT

Disclosed herein is a coil component that includes a coil part embedded in a magnetic element body. The coil part has a structure in which plural interlayer insulating films and plural conductor layers having a coil pattern are alternately stacked. At least one of the conductor layers has a clearance area having no coil pattern and extending radially outward from a center axis of the coil part. The magnetic element body includes a first magnetic resin layer provided in an inner diameter area of the coil part, a second magnetic resin layer provided in a radially outside area of the coil part, and a fifth magnetic resin layer filled in the clearance area and contacting the first and second magnetic resin layers.

### CROSS-REFERENCE TO RELATED APPLICATION

This application claims the benefit of Japanese Patent Application No. 2022-144774, filed on Sep. 12, 2022, the entire disclosure of which is incorporated by reference herein.

### BACKGROUND OF THE ART

### Field of the Art

The present disclosure relates to a coil component and, more particularly, to a coil component having a structure in which a coil part including alternately stacked interlayer insulating films and conductor layers is embedded in a magnetic element body.

### Description of Related Art

JP 2021-052076A discloses a coil component having a structure in which a coil part including alternately stacked interlayer insulating films and conductor layers is embedded in a magnetic element body. In the coil component disclosed in JP 2021-052076A, coil patterns positioned in the respective conductor layers are all wound in less than one turn. A dummy pattern for eliminating a level difference is provided at a part having no coil pattern and overlapping a coil pattern in another conductor layer.

In the coil component described in JP 2021-052076A, a magnetic resin layer embedded in the inner diameter area of the coil part and a magnetic resin layer embedded in the radially outside area of the coil part are magnetically connected to each other through a magnetic resin layer that covers the coil part in the axial direction.

### SUMMARY

The present disclosure provides a technology for further enhancing magnetic characteristics in a coil component having a structure in which a coil part including alternately stacked interlayer insulating films and conductor layers is embedded in a magnetic element body.

A coil component according to one aspect of the present disclosure includes a magnetic element body and a coil part embedded in the magnetic element body and having a structure in which a plurality of interlayer insulating films and a plurality of conductor layers are alternately stacked, wherein the plurality of conductor layers each have a coil pattern, one or more first conductor layers of the plurality of conductor layers each have a clearance area having no coil pattern and extending radially outward from the center axis of the coil part, the magnetic element body includes a first magnetic resin layer provided in the inner diameter area of the coil part, a second magnetic resin layer provided in the radially outside area of the coil part, a third magnetic resin layer covering the coil part from one side in an axial direction of the coil part, a fourth magnetic resin layer covering the coil part from the other side in the axial direction, and a fifth magnetic resin layer filled in the clearance area and contacting the first and second magnetic resin layers, and the other conductor layers of the plurality of conductor layers than the first conductor layer do not have the clearance area filled with the fifth magnetic resin layer.

A coil component according to another aspect of the present disclosure includes a magnetic element body and a coil part embedded in the magnetic element body and having a structure in which a plurality of interlayer insulating films and a plurality of conductor layers are alternately stacked, wherein the plurality of conductor layers each have a coil pattern, a first conductor layer included in the plurality of conductor layers has a clearance area having no coil pattern and extending radially outward from the center axis of the coil part, the magnetic element body includes a first magnetic resin layer provided in the inner diameter area of the coil part, a second magnetic resin layer provided in the radially outside area of the coil part, a third magnetic resin layer covering the coil part from one side in an axial direction of the coil part, a fourth magnetic resin layer covering the coil part from the other side in the axial direction, and a fifth magnetic resin layer filled in the clearance area and contacting the first and second magnetic resin layers, and the clearance area filled with the fifth magnetic resin layer is provided only in the first conductor layer of the plurality of conductor layers.

A coil component according to still another aspect of the present disclosure includes a magnetic element body and a coil part embedded in the magnetic element body and having a structure in which a plurality of interlayer insulating films and a plurality of conductor layers are alternately stacked, wherein the plurality of conductor layers each have a coil pattern, a first conductor layer included in the plurality of conductor layers has a clearance area having no coil pattern and extending radially outward from the center axis of the coil part, the magnetic element body includes a first magnetic resin layer provided in the inner diameter area of the coil part, a second magnetic resin layer provided in the radially outside area of the coil part, a third magnetic resin layer covering the coil part from one side in an axial direction of the coil part, a fourth magnetic resin layer covering the coil part from the other side in the axial direction, and a fifth magnetic resin layer filled in the clearance area and contacting the first and second magnetic resin layers, and in the other conductor layers of the plurality of conductor layers other than the first conductor layer, the first and second magnetic resin layers are isolated by the coil pattern included in the conductor layer.

### BRIEF DESCRIPTION OF THE DRAWINGS

The above features and advantages of the present disclosure will be more apparent from the following description of certain preferred embodiments taken in conjunction with the accompanying drawings, in which:

FIG. 1 is a schematic perspective view for explaining the outer appearance of a coil component 1 according to an embodiment of the present disclosure;

FIG. 2 is a schematic cross-sectional view of the coil component 1;

FIG. 3 is a schematic plan view for explaining the pattern shapes of the conductor layer C0;

FIG. 4 is a schematic plan view for explaining the pattern shapes of the conductor layer C1;

FIG. 5 is a schematic plan view for explaining the pattern shapes of the conductor layer C2;

FIG. 6 is a schematic plan view for explaining the pattern shapes of the conductor layer C3;

FIGS. 7 to 15 are process views for explaining the manufacturing method for the coil component 1;

FIG. 16 is a schematic plan view for explaining the shape of the conductor layer C3 during the manufacturing process;

FIG. 17 is a schematic plan view for explaining the pattern shapes of the conductor layer C0 according to a modification;

FIG. 18 is a schematic plan view for explaining the pattern shapes of the conductor layer C1 according to the modification;

FIG. 19 is a schematic plan view for explaining the pattern shapes of the conductor layer C2 according to the modification; and

FIG. 20 is a schematic plan view for explaining the pattern shapes of the conductor layer C3 according to the modification.

### DETAILED DESCRIPTION OF THE EMBODIMENTS

Preferred embodiments of the present disclosure will be explained below in detail with reference to the accompanying drawings.

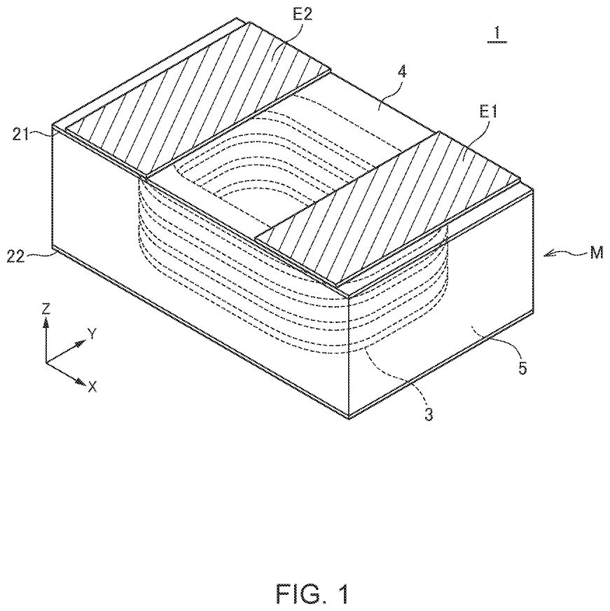

FIG. 1 is a schematic perspective view for explaining the outer appearance of a coil component 1 according to an embodiment of the present disclosure.

As illustrated in FIG. 1, the coil component 1 according to the present embodiment is a chip type coil component having a structure in which a coil part 3 having a coil axis extending in the Z-direction is embedded in a magnetic element body M. The magnetic element body M has a rectangular shape having a long side extending in the X-direction and a short side extending in the Y-direction. The magnetic element body M has a mounting surface 4 and an upper surface 5 which are orthogonal to the coil axis and constitute the XY plane. The mounting surface 4 and the upper surface 5 are positioned on the opposite sides to each other. The mounting surface 4 is provided with terminal electrodes E1 and E2. At the time of mounting, the terminal electrodes E1 and E2 are soldered onto a circuit board with the mounting surface 4 facing the circuit board. That is, when mounted, the coil component 1 illustrated in FIG. 1 is inverted 180°

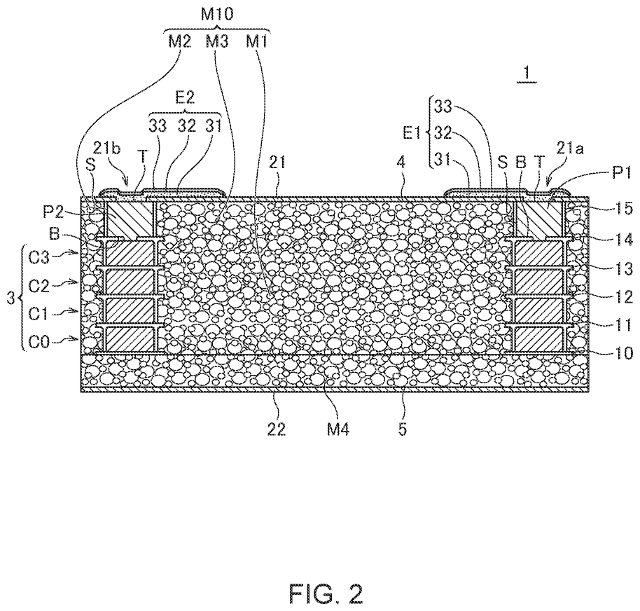

FIG. 2 is a schematic cross-sectional view of the coil component 1 according to the present embodiment.

As illustrated in FIG. 2, the coil component 1 according to the present embodiment has a coil part 3 including interlayer insulating films 10 to 14 and conductor layers C0 to C3 which are alternately stacked in the coil axial direction (Z-direction). The conductor layers C0 to C3 are made of Cu or the like. The magnetic element body M includes magnetic resin layers M4 and M10. The magnetic resin layer M10 includes a magnetic resin layer M1 positioned in the inner diameter area of the coil part 3, a magnetic resin layer M2 positioned in the radially outside area of the coil part 3, and a magnetic resin layer M3 positioned on one side (e.g., the side on which a terminal electrode E2 to be described later is provided) of the coil part 3 in the coil axial direction. The magnetic resin layer M4 is provided on the other side (e.g., a side opposite to the terminal electrode and on which a cover insulating film 22 to be described later is provided) of the coil part 3 in the coil axial direction. Hereinafter, the magnetic resin layers M1 to M4 are referred to as first to fourth magnetic resin layers, respectively, according to circumstances. The magnetic resin layer M4 and M10 are made of a composite magnetic material containing a magnetic filler and binder resin. The composite magnetic material constituting the magnetic resin layer M4 and the composite magnetic material constituting the magnetic resin layer M10 may be the same or different. The magnetic filler may be a metal magnetic material such as iron (Fe) or a permalloy-base material. The binder resin may be epoxy resin.

Conductor posts P1 and P2 are embedded in the magnetic resin layer M3. The conductor posts P1 and P2 are made of Cu or the like and are pillar-shaped conductors extending in the Z-direction. A lower surface B at one end of the conductor post P1 is connected to one end of a coil constituted by the conductor layers C0 to C3, and a lower surface B at one end of the conductor post P2 is connected to the other end of the coil constituted by the conductor layers C0 to C3. On the other hand, upper surfaces T at the other ends of the respective conductor posts P1 and P2 are exposed from the mounting surface 4 so as to be flush with the mounting surface 4 and are connected respectively to the terminal electrodes E1 and E2. Side surfaces S (surfaces along the Z-direction) of the conductor posts P1 and P2 are covered with a post protective film 15. Thus, the post protective film 15 is interposed between the magnetic element body M and the conductor posts P1 and P2, so that contact between the magnetic element body M and the conductor posts P1 and P2 is prevented to insulate them from each other. Further, when the coil component 1 according to the present embodiment having the thus configured conductor posts P1 and P2 is mounted on a circuit board or the like, stress is relived by the conductor posts P1 and P2 to reduce damage to the coil part 3. This increases mounting reliability of the coil component 1.

The mounting surface 4 and upper surface 5 of the magnetic element body M are covered respectively with cover insulating films 21 and 22. The cover insulating film 22 covers substantially the entire upper surface 5, while the cover insulating film 21 has openings 21a and 21b at positions overlapping respectively the conductor posts P1 and P2. As a result, the upper surfaces T (XY plane) of the respective conductor posts P1 and P2 are exposed through the respective openings 21a and 21b of the cover insulating film 21. On the cover insulating film 21, the terminal electrodes E1 and E2 are provided. The terminal electrodes E1 and E2 are each constituted by a resin electrode 31 containing metal powder of Ag and binder resin and Ni and Sn films 32 and 33 formed on the surface of the resin electrode 31. The terminal electrodes E1 and E2 are connected respectively to the upper surfaces T of the conductor posts P1 and P2 through the respective openings 21a and 21b of the cover insulating film 21. Although the mounting surface 4 and upper surface 5 of the magnetic element body M need not necessarily be covered with the cover insulating film 21 and 22, the presence of the cover insulating film 21 prevents contact between the magnetic element body M and the terminal electrode E1 and E2, thereby increasing reliability. Further, the presence of the cover insulating film 22 increases reliability and allows a direction mark to be provided on the upper surface 5.

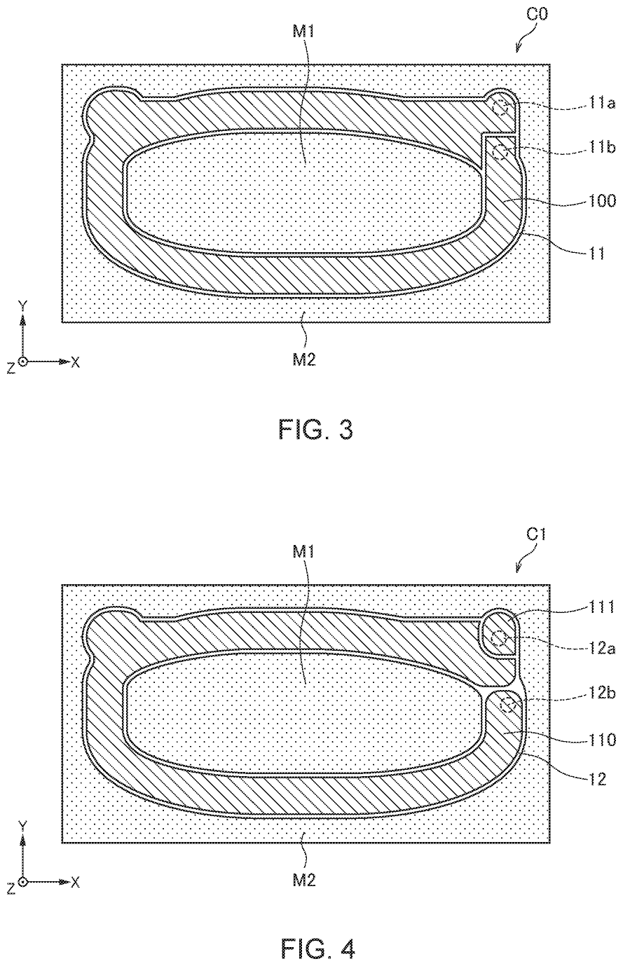

FIGS. 3 to 6 are schematic plan views for explaining the pattern shapes of the conductor layers C0 to C3.

As illustrated in FIG. 3, the conductor layer C0 is provided with a coil pattern 100. The coil pattern 100 is a pattern wound in about one turn, and both ends thereof are connected to the conductor layer C1 through vias 11a and 11b formed in the interlayer insulating film 11. The inner diameter area of the coil pattern 100 is provided with the magnetic resin layer M1, and the outside area thereof is provided with the magnetic resin layer M2. A gap between one end and the other end of the coil pattern 100 is filled with the interlayer insulating film 11. Therefore, in the plane of the conductor layer C0, the magnetic resin layers M1 and M2 are isolated from each other.

As illustrated in FIG. 4, the conductor layer C1 is provided with a coil pattern 110 and a connection pattern 111. The coil pattern 110 is a pattern wound in about one turn. One end of the coil pattern 110 is connected to the other end of the coil pattern 100 in the conductor layer C0 through the via 11b formed in the interlayer insulating film 11, and the other end thereof is connected to the conductor layer C2 through a via 12b formed in the interlayer insulating film 12. The connection pattern 111 is provided at a position overlapping the one end of the coil pattern 100 in the conductor layer C0. The connection pattern 111 is connected to the one end of the coil pattern 100 in the conductor layer C0 through a via 11a formed in the interlayer insulating film 11 and to the conductor layer C2 through a via 12a formed in the interlayer insulating film 12. The inner diameter area of the coil pattern 110 is provided with the magnetic resin layer M1, and the outside area thereof is provided with the magnetic resin layer M2. A gap between one end and the other end of the coil pattern 110 is filled with the interlayer insulating film 12. Therefore, in the plane of the conductor layer C1, the magnetic resin layers M1 and M2 are isolated from each other.

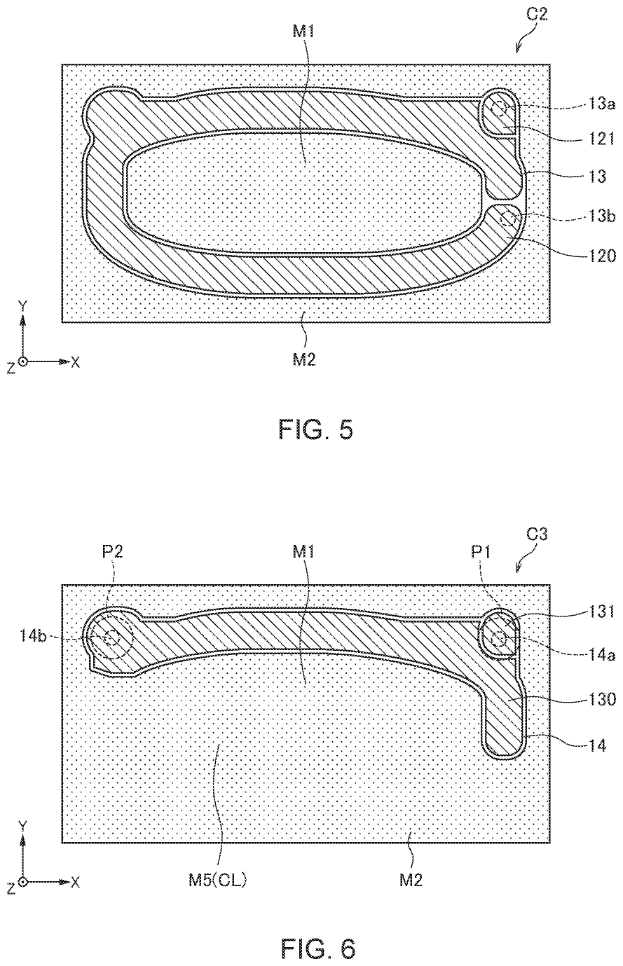

As illustrated in FIG. 5, the conductor layer C2 is provided with a coil pattern 120 and a connection pattern 121. The coil pattern 120 is a pattern wound in about one turn. One end of the coil pattern 120 is connected to the other end of the coil pattern 110 in the conductor layer C1 through the via 12b formed in the interlayer insulating film 12, and the other end thereof is connected to the conductor layer C3 through a via 13b formed in the interlayer insulating film 13. The connection pattern 121 is provided at a position overlapping the connection pattern 111 provided in the conductor layer C1. The connection pattern 121 is connected to the connection pattern 111 in the conductor layer C1 through the via 12a formed in the interlayer insulating film 12 and to the conductor layer C3 through a via 13a formed in the interlayer insulating film 13. The inner diameter area of the coil pattern 120 is provided with the magnetic resin layer M1, and the outside area thereof is provided with the magnetic resin layer M2. A gap between one end and the other end of the coil pattern 120 is filled with the interlayer insulating film 13. In the plane of the conductor layer C2, the magnetic resin layers M1 and M2 are isolated from each other.

As illustrated in FIG. 6, the conductor layer C3 is provided with a coil pattern 130 and a connection pattern 131. The coil pattern 130 is a pattern wound in about 0.5 turns. One end of the coil pattern 130 is connected to the other end of the coil pattern 120 in the conductor layer C2 through the via 13b formed in the interlayer insulating film 13, and the other end thereof is connected to the conductor post P2 through a via 14b formed in the interlayer insulating film 14. The connection pattern 131 is provided at a position overlapping the connection pattern 121 provided in the conductor layer C2. The connection pattern 131 is connected to the connection pattern 121 in the conductor layer C2 through the via 13a formed in the interlayer insulating film 13 and to the conductor post P1 through a via 14a formed in the interlayer insulating film 14. The inner diameter area of the coil pattern 130 is provided with the magnetic resin layer M1, and the outside area thereof is provided with the magnetic resin layer M2. A clearance area CL where no coil pattern exists is provided between the one end and the other end of the coil pattern 130. The clearance area CL is an area to cut the coil pattern 130 radially outward from the center axis of the coil part 3 and is provided along the long side direction (X-direction) and the short side direction (Y-direction) in the example illustrated in FIG. 6. The clearance area CL is filled not with the interlayer insulating film 14 but with a magnetic resin layer M5 constituting a part of the magnetic resin layer M10. The magnetic resin layer M5 contacts the magnetic resin layers M1 and M2. As a result, in the plane of the conductor layer C3, the magnetic resin layers M1 and M2 are connected to each other through the magnetic resin layer M5.

With the above configuration, the coil patterns 100, 110, 120, and 130 are connected in series between the terminal electrodes E1 and E2 to form a coil of about 3.5 turns in total. The coil component 1 according to the present embodiment is an embedded type coil component in which the coil part 3 including the alternately stacked interlayer insulating films 10 to 14 and conductor layers C0 to C3 is embedded in the magnetic element body M, which is different in structure from a stacked type coil component in which magnetic sheets made of ceramic or the like and coil patterns are alternately stacked. For example, in the stacked type coil component, a magnetic sheet is interposed between coil patterns adjacent in the stacking direction, while in the coil component 1 according to the present embodiment, coil patterns adjacent in the stacking direction are insulated by the interlayer insulating film, and the magnetic element body M is not interposed between the coil patterns. The coil component 1 according to the present embodiment is also different in structure from a sheet coil of a type in which a coil pattern is formed on a printed board.

In the present embodiment, the magnetic resin layer M1 positioned in the inner diameter area of the coil part 3 and the magnetic resin layer M2 positioned in the outside area of the coil part 3 are connected to each other not only through the magnetic resin layers M3 and M4 but also through the magnetic resin layer M5 positioned in the clearance area CL in the conductor layer C3, increasing the volume of the magnetic element body M, which makes it possible to achieve higher magnetic characteristics. In addition, the conductor layer C3 including the clearance area CL is positioned at the end position on one side in the Z-direction, so that the magnetic resin layers M3 and M5 are integrated, making it possible to further enhance magnetic characteristics. On the other hand, the remaining conductor layers C0 to C2 do not include the clearance area CL filled with the magnetic resin layer M5 and respectively have the coil patterns 100, 110, and 120 each being wound in about one turn, making it possible to ensure a sufficient number of turns. The coil patterns 100, 110, and 120 provided in the respective conductor layers C0 to C2 may each have one or more turns.

The following describes a manufacturing method for the coil component 1 according to the present embodiment.

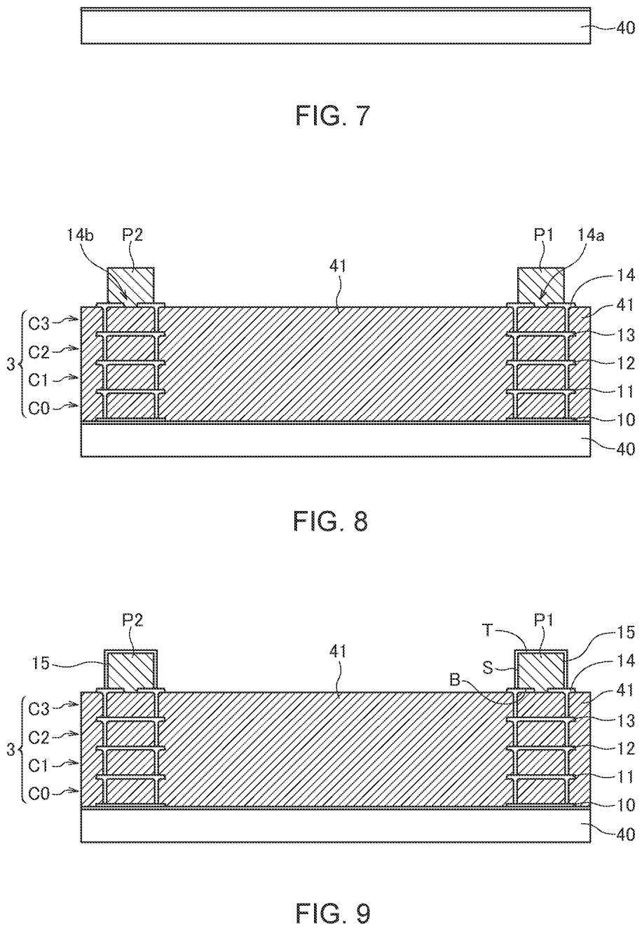

FIGS. 7 to 15 are process views for explaining the manufacturing method for the coil component 1 according to the present embodiment. Although FIGS. 7 to 15 each illustrate only an area corresponding to one coil component 1, a plurality of coil components 1 are actually manufactured at the same time using an aggregate substrate.

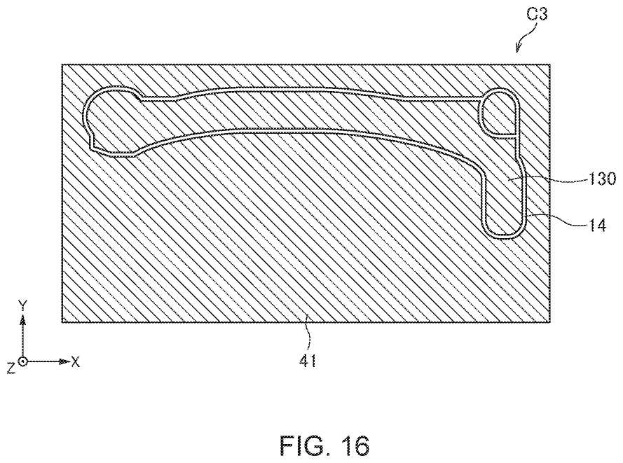

First, a support substrate 40 is prepared (FIG. 7), and interlayer insulating films 10 to 14 and conductor layers C0 to C3 are alternately formed to form the coil part 3. After that, the vias 14a and 14b are formed in the interlayer insulating film 14, and the conductor posts P1 and P2 are formed (FIG. 8). The conductor layers C0 to C3 and conductor posts P1 and P2 can be formed by electrolytic plating. The conductor layers C0 to C3 include a sacrificial pattern 41 positioned in the inner diameter area of the coil part 3 and in the outside area of the coil part 3. In the conductor layers C0 to C2, the sacrificial pattern 41 positioned in the inner diameter areas of the coil patterns 100, 110, and 120 and the sacrificial pattern 41 positioned in the outside areas of the coil patterns 100, 110, and 120 do not contact each other but are isolated, while in the conductor layer C3, the sacrificial pattern 41 positioned in the inner diameter area of the coil pattern 130 and the sacrificial pattern 41 positioned in the outside area of the coil pattern 130 are integrated with each other through the clearance area CL, as illustrated in FIG. 16.

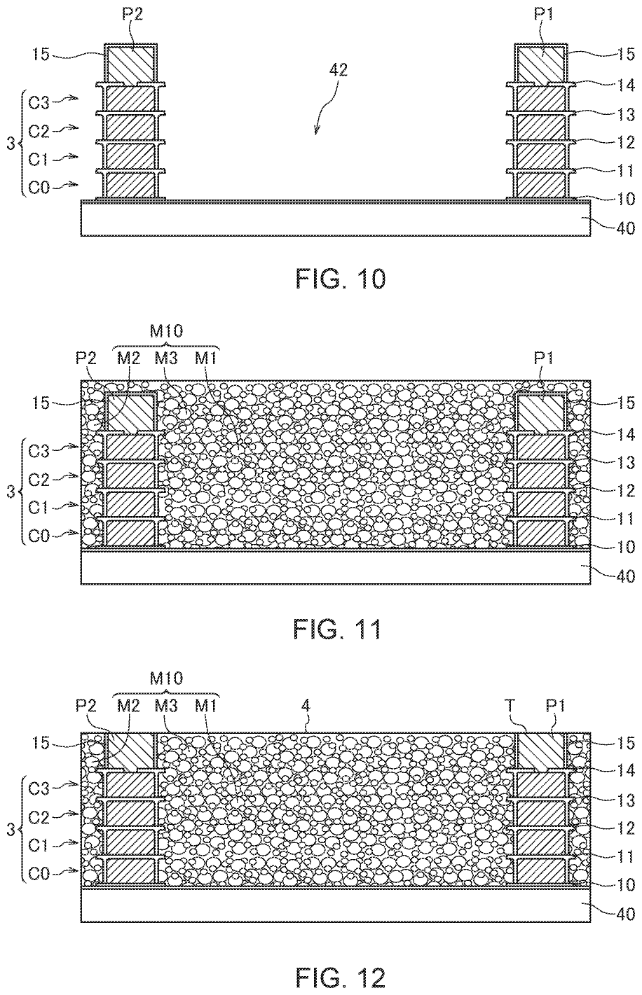

Then, the post protective film 15 covering the entire exposed surface of each of the conductor posts P1 and P2 is formed (FIG. 9). The entire exposed surface of each of the conductor posts P1 and P2 includes the side surface S along the Z-direction and an upper surface T constituting the XY plane. In this state, wet etching is performed to remove the sacrificial pattern 41 (FIG. 10). The coil patterns constituting the coil part 3 are covered with the interlayer insulating films 10 to 14 and are thus not etched. Similarly, the conductor posts P1 and P2 are covered with the post protective film 15 and are thus not etched. As a result, a space 42 is formed in the inner diameter area and outside area of the coil part 3. The space 42 is also formed in the clearance area CL in the conductor layer C3.

Then, the space 42 formed as a result of the removal of the sacrificial pattern 41 is filled with the magnetic resin layer M10 (FIG. 11). As a result, the inner diameter area of the coil part 3 is filled with the magnetic resin layer M1, the radially outside area of the coil part 3 is filled with the magnetic resin layer M2, and one side of the coil part 3 in the coil axial direction is filled with the magnetic resin layer M3. Further, the clearance area CL in the conductor layer C3 is filled with the magnetic resin layer M5. The magnetic resin layers M1 to M3 and M5 have no boundary therebetween but are integrated with one another. Then, the surface of the magnetic resin layer M3 is ground until the conductor posts P1 and P2 are exposed (FIG. 12). As a result, the mounting surface 4 of the magnetic resin layer M3 and the upper surfaces T of the conductor posts P1 and P2 are flush with one another. Further, as compared with a state before grinding, flatness of the magnetic resin layer M3 on the mounting surface 4 is significantly improved.

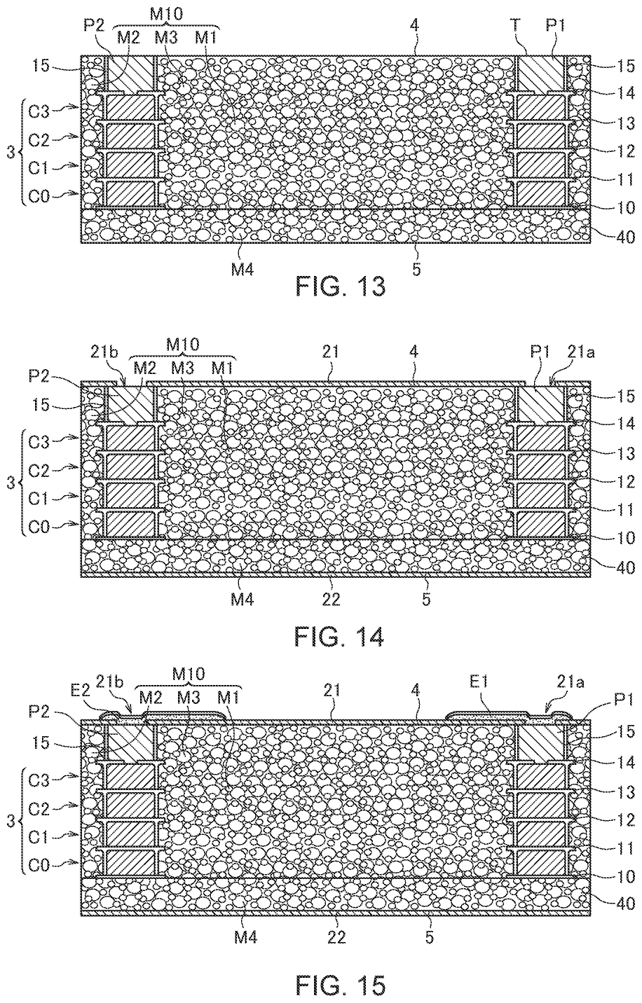

Then, the support substrate 40 is removed, and the magnetic resin layer M4 is formed on the lower surface side of the magnetic resin layer M10 so as to cover the interlayer insulating film 10 (FIG. 13). Thereafter, the surface of the magnetic resin layer M4 may be ground for smoothing the upper surface 5. Then, the cover insulating films 21 and 22 are formed respectively on the mounting surface 4 and upper surface 5 of the magnetic element body M, and the openings 21a and 21b are formed in the cover insulating film 21 so as to expose therethrough a part of the upper surface T of each of the conductor posts P1 and P2 (FIG. 14).

Then, the terminal electrodes E1 and E2 are formed on the cover insulating film 21 so as to be connected respectively to the conductor posts P1 and P2 (FIG. 15), followed by dicing for singulation, whereby the coil component 1 according to the present embodiment is completed.

As described above, in the present embodiment, the sacrificial pattern 41 is disposed at a portion corresponding to the clearance area CL in the conductor layer C3, so that it is possible to prevent the occurrence of a level difference (recess having no conductor pattern) without disposing a dummy pattern at this portion. After removal of the sacrificial pattern 41, the clearance area CL is filled with the magnetic resin layer M5, with the result that the magnetic resin layer M1 positioned in the inner diameter area of the coil part 3 and the magnetic resin layer M2 positioned in the outside area of the coil part 3 are connected to each other through the magnetic resin layer M5.

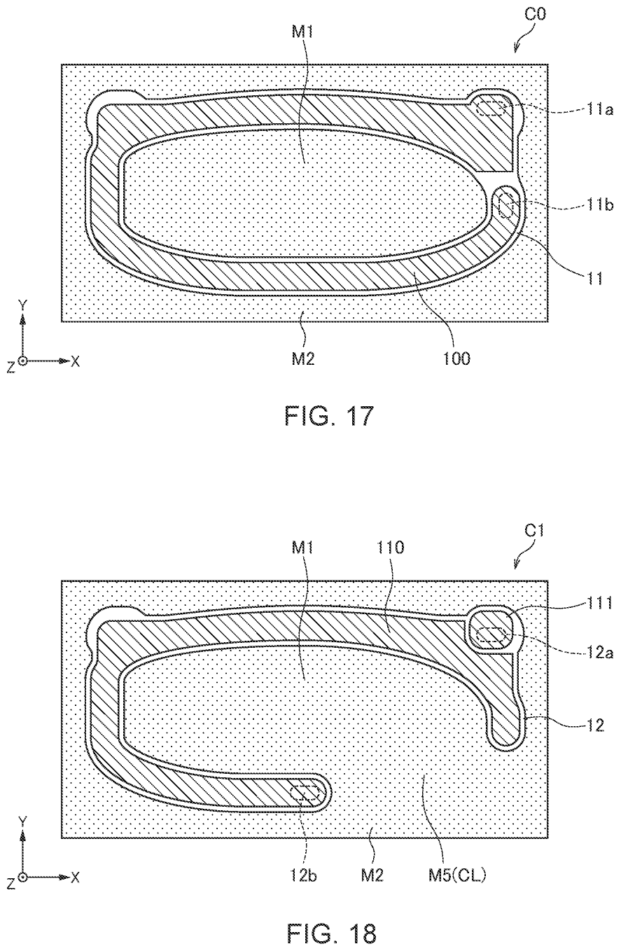

FIGS. 17 to 20 are schematic plan views for explaining the pattern shapes of the conductor layers C0 to C3 according to a modification.

As illustrated in FIG. 17, the conductor layer C0 according to the modification is provided with the coil pattern 100 wound in about one turn as is the case with the conductor layer C0 illustrated in FIG. 3, and both ends thereof are connected to the conductor layer C1 through the vias 11a and 11b formed in the interlayer insulating film 11. The inner diameter area of the coil pattern 100 is provided with the magnetic resin layer M1, and the outside area thereof is provided with the magnetic resin layer M2. A gap between one end and the other end of the coil pattern 100 is filled with the interlayer insulating film 11. Therefore, in the plane of the conductor layer C0, the magnetic resin layers M1 and M2 are isolated from each other.

As illustrated in FIG. 18, the conductor layer C1 according to the modification is provided with the coil pattern 110 and connection pattern 111. The coil pattern 110 is a pattern wound in about ¾ turns. One end of the coil pattern 110 is connected to the other end of the coil pattern 100 in the conductor layer C0 through the via 11b formed in the interlayer insulating film 11, and the other end thereof is connected to the conductor layer C2 through the via 12b formed in the interlayer insulating film 12. The connection pattern 111 is provided at a position overlapping the one end of the coil pattern 100 in the conductor layer C0. The connection pattern 111 is connected to the one end of the coil pattern 100 in the conductor layer C0 through the via 11a formed in the interlayer insulating film 11 and to the conductor layer C2 through the via 12a formed in the interlayer insulating film 12. The inner diameter area of the coil pattern 110 is provided with the magnetic resin layer M1, and the outside area thereof is provided with the magnetic resin layer M2. The clearance area CL where no coil pattern exists is provided between the one end and the other end of the coil pattern 110. The clearance area CL is filled not with the interlayer insulating film 12 but with the magnetic resin layer M5 constituting a part of the magnetic resin layer M10. The magnetic resin layer M5 contacts the magnetic resin layers M1 and M2. As a result, in the plane of the conductor layer C1, the magnetic resin layers M1 and M2 are connected to each other through the magnetic resin layer M5.

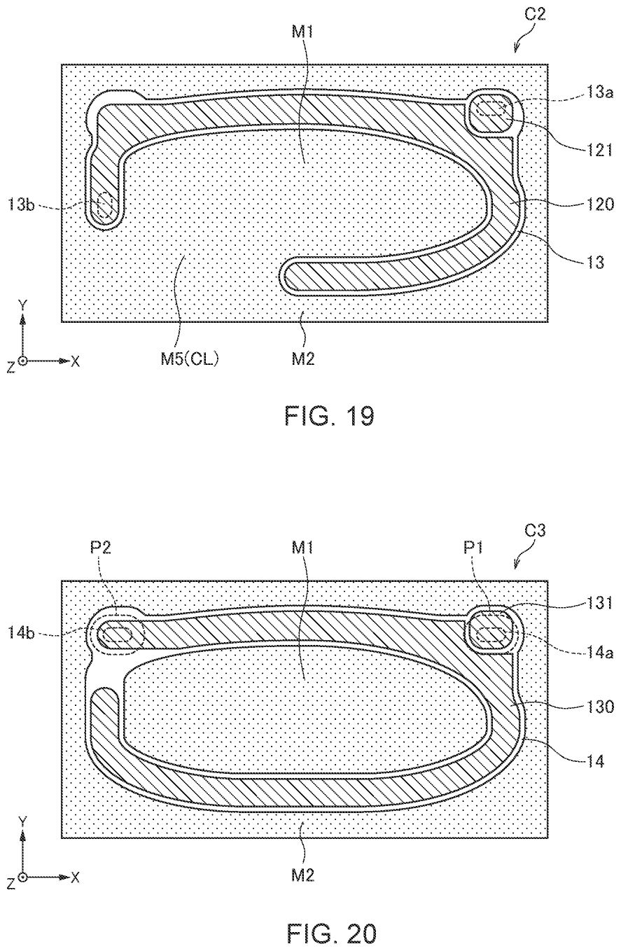

As illustrated in FIG. 19, the conductor layer C2 according to the modification is provided with the coil pattern 120 and the connection pattern 121. The coil pattern 120 is a pattern wound in about ¾ turns. One end of the coil pattern 120 is connected to the other end of the coil pattern 110 in the conductor layer C1 through the via 12b formed in the interlayer insulating film 12, and the other end thereof is connected to the conductor layer C3 through the via 13b formed in the interlayer insulating film 13. The connection pattern 121 is provided at a position overlapping the connection pattern 111 provided in the conductor layer C1. The connection pattern 121 is connected to the connection pattern 111 in the conductor layer C1 through the via 12a formed in the interlayer insulating film 12 and to the conductor layer C3 through the via 13a formed in the interlayer insulating film 13. The inner diameter area of the coil pattern 120 is provided with the magnetic resin layer M1, and the outside area thereof is provided with the magnetic resin layer M2. The clearance area CL where no coil pattern exists is provided between the one end and the other end of the coil pattern 120. The clearance area CL is filled not with the interlayer insulating film 13 but with the magnetic resin layer M5 constituting a part of the magnetic resin layer M10. The magnetic resin layer M5 contacts the magnetic resin layers M1 and M2. As a result, in the plane of the conductor layer C2, the magnetic resin layers M1 and M2 are connected to each other through the magnetic resin layer M5.

As illustrated in FIG. 20, the conductor layer C3 is provided with the coil pattern 130 and connection pattern 131. The coil pattern 130 is a pattern wound in about one turn. One end of the coil pattern 130 is connected to the other end of the coil pattern 120 in the conductor layer C2 through the via 13b formed in the interlayer insulating film 13, and the other end thereof is connected to the conductor post P2 through the via 14b formed in the interlayer insulating film 14. The connection pattern 131 is provided at a position overlapping the connection pattern 121 provided in the conductor layer C2. The connection pattern 131 is connected to the connection pattern 121 in the conductor layer C2 through the via 13a formed in the interlayer insulating film 13 and to the conductor post P1 through the via 14a formed in the interlayer insulating film 14. The inner diameter area of the coil pattern 130 is provided with the magnetic resin layer M1, and the outside area thereof is provided with the magnetic resin layer M2. A gap between one end and the other end of the coil pattern 130 is filled with the interlayer insulating film 14. Therefore, in the plane of the conductor layer C3, the magnetic resin layers M1 and M2 are isolated from each other.

As described above, in the modification, the magnetic resin layer M1 and the magnetic resin layer M2 are connected to each other through the magnetic resin layer M5 positioned in the clearance areas CL in the respective conductor layers C1 and C2. The conductor layers C1 and C2 each having the clearance area CL are inner layers among the plurality of conductor layers C0 to C3 that are each not positioned at an end portion in the axial direction, allowing each of the coil patterns 100 and 130 positioned at the end position in the axial direction to have about one turn, which can enhance the mechanical strength of the entire structure. Further, the conductor layers C1 and C2 each having the clearance area CL are adjacent in the axial direction, and the planer positions of the clearance areas CL are different from each other, thereby facilitating pattern design. In this case, the clearance area CL in the conductor layer C1 and the clearance area CL in the conductor layer C2 need not necessarily overlap each other in a plan view as seen in the axial direction.

While the preferred embodiment of the present disclosure has been described, the present disclosure is not limited to the above embodiment, and various modifications may be made within the scope of the present disclosure, and all such modifications are included in the present disclosure.

For example, although the coil part 3 includes the four conductor layers C0 to C3 in the above embodiment, the number of the conductor layers included in the coil part 3 is not particularly limited. Further, although the numbers of turns of the coil patterns 100, 110, and 120 provided in the respective conductor layers C0 to C2 are each about one turn in the above embodiment, the number of turns of the coil pattern provided in each of the conductor layers is not particularly limited.

The technology according to the present disclosure includes the following configuration examples but not limited thereto.

A coil component according to one aspect of the present disclosure includes a magnetic element body and a coil part embedded in the magnetic element body and having a structure in which a plurality of interlayer insulating films and a plurality of conductor layers are alternately stacked, wherein the plurality of conductor layers each have a coil pattern, one or more first conductor layers of the plurality of conductor layers each have a clearance area having no coil pattern and extending radially outward from the center axis of the coil part, the magnetic element body includes a first magnetic resin layer provided in the inner diameter area of the coil part, a second magnetic resin layer provided in the radially outside area of the coil part, a third magnetic resin layer covering the coil part from one side in an axial direction of the coil part, a fourth magnetic resin layer covering the coil part from the other side in the axial direction, and a fifth magnetic resin layer filled in the clearance area and contacting the first and second magnetic resin layers, and the other conductor layers of the plurality of conductor layers than the first conductor layer do not have the clearance area filled with the fifth magnetic resin layer.

According to the present disclosure, the volume of the magnetic element body is increased, making it possible to further enhance magnetic characteristics of the coil part.

In the present disclosure, only one layer of the plurality of conductor layers may be formed as the first conductor layer. This facilitates pattern design.

In the present disclosure, the one first conductor layer may be positioned at an end portion on one side of the plurality of conductor layers in the axial direction. This integrates the fifth and third magnetic resin layers, making it possible to further enhance magnetic characteristics.

The coil component according to the one aspect of the present disclosure may further include a terminal electrode covering the third magnetic resin layer and a conductor post embedded in the third magnetic resin layer having one end connected to one end of the coil pattern positioned in the first conductor layer and the other end connected to the terminal electrode. This allows the surface of the third magnetic resin layer to be used as a mounting surface.

In the present disclosure, the magnetic element body may have a rectangular shape having a long side extending in a first direction and a short side extending in a second direction perpendicular to the first direction as viewed in the axial direction, and the clearance area may extend in the first direction. The long side of the magnetic element body has high magnetic density, which further enhances magnetic characteristics.

A coil component according to another aspect of the present disclosure includes a magnetic element body and a coil part embedded in the magnetic element body and having a structure in which a plurality of interlayer insulating films and a plurality of conductor layers are alternately stacked, wherein the plurality of conductor layers each have a coil pattern, a first conductor layer included in the plurality of conductor layers has a clearance area having no coil pattern and extending radially outward from the center axis of the coil part, the magnetic element body includes a first magnetic resin layer provided in the inner diameter area of the coil part, a second magnetic resin layer provided in the radially outside area of the coil part, a third magnetic resin layer covering the coil part from one side in an axial direction of the coil part, a fourth magnetic resin layer covering the coil part from the other side in the axial direction, and a fifth magnetic resin layer filled in the clearance area and contacting the first and second magnetic resin layers, and the clearance area filled with the fifth magnetic resin layer is provided only in the first conductor layer of the plurality of conductor layers.

According to the present disclosure, the volume of the magnetic element body is increased, making it possible to further enhance magnetic characteristics of the coil part.

A coil component according to still another aspect of the present disclosure includes a magnetic element body and a coil part embedded in the magnetic element body and having a structure in which a plurality of interlayer insulating films and a plurality of conductor layers are alternately stacked, wherein the plurality of conductor layers each have a coil pattern, a first conductor layer included in the plurality of conductor layers has a clearance area having no coil pattern and extending radially outward from the center axis of the coil part, the magnetic element body includes a first magnetic resin layer provided in the inner diameter area of the coil part, a second magnetic resin layer provided in the radially outside area of the coil part, a third magnetic resin layer covering the coil part from one side in an axial direction of the coil part, a fourth magnetic resin layer covering the coil part from the other side in the axial direction, and a fifth magnetic resin layer filled in the clearance area and contacting the first and second magnetic resin layers, and in the other conductor layers of the plurality of conductor layers other than the first conductor layer, the first and second magnetic resin layers are isolated by the coil pattern included in the conductor layer.

According to the present disclosure, the volume of the magnetic element body is increased, making it possible to further enhance magnetic characteristics of the coil part.

In the present disclosure, the plurality of conductor layers may include two layers of the first conductor layer, and the two first conductor layers may be adjacent in the axial direction. Further, the clearance areas in the two respective first conductor layers may differ in planar position as viewed in the axial direction. This facilitates pattern design. Furthermore, the two first conductor layers may be inner layers among the plurality of conductor layers that are each not positioned at an end portion in the axial direction. This can enhance the mechanical strength of the entire structure.

As described above, according to the present disclosure, there can be provided a technology for further enhancing magnetic characteristics in a coil component having a structure in which a coil part including alternately stacked interlayer insulating films and conductor layers is embedded in a magnetic element body.

What is claimed is:

1. A coil component comprising:
a magnetic element body; and
a coil part embedded in the magnetic element body,
wherein the coil part has a structure in which a plurality of interlayer insulating films and a plurality of conductor layers are alternately stacked,
wherein each of the plurality of conductor layers has a coil pattern,
wherein one or more first conductor layers of the plurality of conductor layers each have a clearance area having no coil pattern and extending radially outward from a center axis of the coil part,
wherein the magnetic element body includes:
a first magnetic resin layer provided in an inner diameter area of the coil part;
a second magnetic resin layer provided in a radially outside area of the coil part;
a third magnetic resin layer covering the coil part from one side in an axial direction of the coil part;
a fourth magnetic resin layer covering the coil part from other side in the axial direction; and
a fifth magnetic resin layer filled in the clearance area and contacting the first and second magnetic resin layers, and
wherein other conductor layers of the plurality of conductor layers than the first conductor layer do not have the clearance area filled with the fifth magnetic resin layer.

2. The coil component as claimed in claim 1, wherein only one layer of the plurality of conductor layers is formed as the first conductor layer.

3. The coil component as claimed in claim 2, wherein the first conductor layer is positioned at an end portion on one side of the plurality of conductor layers in the axial direction.

4. The coil component as claimed in claim 3, further comprising:
a terminal electrode covering the third magnetic resin layer; and
a conductor post embedded in the third magnetic resin layer having one end connected to one end of the coil pattern positioned in the first conductor layer and other end connected to the terminal electrode.

5. The coil component as claimed in claim 1,
wherein the magnetic element body has a rectangular shape having a long side extending in a first direction and a short side extending in a second direction perpendicular to the first direction as viewed in the axial direction, and
wherein the clearance area extends in the first direction.

6. A coil component comprising:
a magnetic element body; and
a coil part embedded in the magnetic element body,
wherein the coil part has a structure in which a plurality of interlayer insulating films and a plurality of conductor layers are alternately stacked,
wherein each of the plurality of conductor layers has a coil pattern,
wherein a first conductor layer included in the plurality of conductor layers has a clearance area having no coil pattern and extending radially outward from a center axis of the coil part,
wherein the magnetic element body includes:
a first magnetic resin layer provided in an inner diameter area of the coil part;
a second magnetic resin layer provided in a radially outside area of the coil part;
a third magnetic resin layer covering the coil part from one side in an axial direction of the coil part;
a fourth magnetic resin layer covering the coil part from other side in the axial direction; and
a fifth magnetic resin layer filled in the clearance area and contacting the first and second magnetic resin layers, and
wherein the clearance area filled with the fifth magnetic resin layer is provided only in the first conductor layer of the plurality of conductor layers.

7. A coil component comprising:
a magnetic element body; and
a coil part embedded in the magnetic element body,
wherein the coil part has a structure in which a plurality of interlayer insulating films and a plurality of conductor layers are alternately stacked,
wherein each of the plurality of conductor layers has a coil pattern,
wherein a first conductor layer included in the plurality of conductor layers has a clearance area having no coil pattern and extending radially outward from a center axis of the coil part,
wherein the magnetic element body includes:
a first magnetic resin layer provided in an inner diameter area of the coil part;
a second magnetic resin layer provided in a radially outside area of the coil part;
a third magnetic resin layer covering the coil part from one side in an axial direction of the coil part;
a fourth magnetic resin layer covering the coil part from other side in the axial direction; and
a fifth magnetic resin layer filled in the clearance area and contacting the first and second magnetic resin layers, and
wherein, in other conductor layers of the plurality of conductor layers other than the first conductor layer, the first and second magnetic resin layers are isolated by the coil pattern included in the conductor layer.

8. The coil component as claimed in claim 7,
wherein the plurality of conductor layers include two layers of the first conductor layer, and
wherein the two first conductor layers are adjacent in the axial direction.

9. The coil component as claimed in claim 8, wherein the clearance areas in the two respective first conductor layers differ in planar position as viewed in the axial direction.

10. The coil component as claimed in claim 8, wherein the two first conductor layers are inner layers among the plurality of conductor layers that are each not positioned at an end portion in the axial direction.
